(19) United States
(12) Patent Application Publication
(10) Pub. No.: US 2006/0260425 A1
(43) Pub. Date: Nov. 23, 2006

(54) Linear guide apparatus

(75) Inventors: Yoshinori Mizumura, Kanagawa (JP); Wei Xu, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 11/342,671

(22) Filed: Jan. 31, 2006

(30) Foreign Application Priority Data
Jan. 31, 2005 (JP) P. 2005-023655
Jan. 13, 2006 (JP) P. 2006-006426

(51) Int. Cl. F16H 3/06

(52) U.S. Cl. 74/89.32

(57) ABSTRACT

In a linear guide apparatus 1 including a rail 2 having rail track grooves 4a formed respectively in upper corner portions thereof, rail mounting holes 3 extending through the rail 2 in a direction of a height of the rail, a rail cover 16 covering the rail mounting holes 3 over an entire length of the rail, and a slider 5 for linearly moving on the rail 2, a protrusion 15, which has a width larger than a bore of the rail mounting holes 3, and extends over the entire longitudinal length of the rail 2, is formed on a rail upper surface 2a, and the rail cover 16 is mounted on this protrusion.

### BACKGROUND OF THE INVENTION

1. Technical Field

This invention relates to a linear guide apparatus provided at a guide portion of a machinery, such as a machine tool (e.g. a cutting machine or a grinding machine), a wood working machine, a cutter, an injection molding machine and a measuring instrument, so as to linearly move a carriage such as a table.

2. Background Art

Generally, in a linear guide apparatus, a slider, so constructed as to move relative to a rail (mounted on a base bed or the like of a machinery by bolts or the like, using rail mounting holes formed in the rail) through rolling members circulating within the slider, is fitted on the rail, and the rail mounting holes, open to an upper surface of the rail, are covered with a rail cover, thereby preventing foreign matters, such as dirt, dust and working chips, from intruding into the inside of the slider.

In this case, usually, the rail cover, having a flat surface portion for covering the upper surface of the rail over an entire width thereof and also having acutely-bent side edge portions, is engaged in undercut portions formed in upper portions of side surfaces of the rail, and is thus mounted on the rail (see, for example, Japanese Patent Examined Publication No. JP-B-2719985).

Such a rail cover covers the upper surface of the rail over the entire width thereof, and therefore in the case where the rolling members are balls, there is encountered a problem that the rail cover can not be mounted on a linear guide apparatus employing a rail having rail track grooves formed respectively in corner portions each formed by the upper surface of the rail and a respective one of opposite side surfaces thereof.

Therefore, in a conventional linear guide apparatus employing a rail having rail track grooves formed respectively in upper corner portions thereof, a slider is linearly moved on the rail by balls rolling in load passageways formed by the rail track grooves, formed in the rail, and slider track grooves formed in the slider. And, a channel-shaped groove portion, having a width smaller than the distance between the rail track grooves formed respectively in the upper opposite side corner portions of the rail, is formed in an upper surface of the rail over an entire length thereof, and rail mounting holes are formed through a bottom surface of this groove portion in the direction of the height of the rail, and a flat plate-like rail cover, having resiliency, is fitted in the groove portion to be mounted therein, and seal members, mounted on the slider, slide over the rail cover, thereby preventing foreign matters from intruding into the inside of the slider (see, for example, Japanese Utility Model Examined Publication No. JP-UM-B-2581865).

However, in the technique of the above-mentioned JP-UM-B-2581865 Publication, the flat plate-like rail cover, having resiliency, is fitted in the channel-shaped groove portion formed in the upper surface of the rail, and therefore when the width of the groove portion is larger than the width of the rail cover, there is encountered a problem that foreign matters enter a gap therebetween, and the foreign matters, entering the gap, intrude into the inside of the slider.

And besides, when the width of the groove portion is smaller than the width of the rail cover, the rail cover is deformed outwardly into a convexly arcuate shape, and a lip portion of the seal member is pushed up by this arcuate surface, and a gap develops at the connected portion of the rail upper surface and the rail cover or other portion, thus inviting a problem that a sealing performance is affected.

Therefore, it is necessary to select the rail cover suited for the groove portion and then to mount it in the groove portion, and it is also necessary to very precisely form the width of the groove portion and the width of the rail cover, and time and labor required for the assembling operation, as well as time and labor required for producing the rail and the rail cover, increases, so that the production cost of the linear guide apparatus increases.

Further, there is known a linear guide apparatus provided with a rail (shown for example in Japanese Utility Model Examined Publication No. JP-UM-B-6-2027), in which a flat plate-like rail cover is fitted in a channel-shaped groove portion formed in an upper surface of the rail, and is bonded thereto, and longitudinally-opposite end portions of the rail cover are bent, and these opposite end portions are held respectively by tape holders screw-fastened respectively to end surfaces of the rail.

A linear guide apparatus (which is similar in construction to that of the above JP-UM-B-6-2027), having a flat plate-like rail cover adhesively bonded to an upper surface of a rail, is disclosed in Japanese Patent Unexamined Publication No. JP-A-1-140936.

However, in the linear guide apparatus of the above JP-UM-B-6-2027 Publication, the flat plate-like rail cover is fitted in the channel-shaped groove portion formed in the upper surface of the rail, and is bonded thereto, and the longitudinally-opposite end portions of the rail cover are bent, and these opposite end portions are held respectively by the tape holders screw-fastened respectively to the end surfaces of the rail. Therefore, in the production of the rail, it is necessary to work the rail upper surface to form the groove portion therein, and it is also necessary to work the end surfaces to form screw holes therein, and this invites a problem that the time, required for producing the rail, increases, so that the efficiency of the production thereof is lowered.

The above problem entails the difficulty in formation of the groove portion in the upper surface of the rail, and also entails the increased time and labor for the production, so that the production cost of the rail increases.

Furthermore, in the linear guide apparatus of the above JP-A-1-140936, the flat plate-like rail cover is bonded by an adhesive to the rail upper surface to cover this rail upper surface. Therefore, in the case where the apparatus is used in an environment in which a water soluble material such as a coolant cutting liquid, used in a machine tool, is splashed on the apparatus, the water soluble material penetrates particularly into a gap between that portion of the flat plate-like rail cover, disposed near to the side surface of the rail, and the rail upper surface, so that the adhesive property of the adhesive is deteriorated, thus inviting a problem that the rail cover is lifted up or disengaged.

### SUMMARY OF THE INVENTION

This invention has been made in order to solve the above problems, and an object of the invention is to provide means for facilitating the mounting of a rail cover even when a rail has rail track grooves formed in upper corner portion thereof, thereby facilitating the production of the rail, and also to provide means for maintaining the adhesion of the rail cover to a rail upper surface.

In order to achieve the above object, according to a first aspect of the present invention, there is provided a linear guide apparatus comprising:

a rail including:
rail track grooves formed respectively in corner portions each formed by an upper surface of the rail and a respective one of widthwise-opposite side surfaces of the rail; and
rail mounting holes extending through the rail in a direction of a height of the rail;

a slider for linearly moving on the rail; and

a protrusion which is formed on the upper surface of the rail, and has a width larger than a diameter of the rail mounting holes, and extends over an entire axial length of the rail.

According to a 2nd aspect of the present invention depending from the first aspect, preferably, the protrusion has a rectangular cross-sectional shape.

According to a 3rd aspect of the present invention depending from the first aspect, preferably, the protrusion has slanting surfaces formed respectively at two corner portions each defined by an upper surface of the protrusion and a respective one of widthwise-opposite side surfaces of the protrusion, the distance between the slanting surfaces in the widthwise direction being increasing toward a lower surface of the rail.

According to a 4th aspect of the present invention depending from the first aspect, preferably, each of the opposite side surfaces of the protrusion is formed by a plurality of inclination surfaces respectively having a plurality of angles relative to the upper surface of the rail.

According to a 5th aspect of the present invention depending from the first aspect, preferably, a surface, lying between the upper surface of the protrusion and the rail track groove, is a ground surface.

According to a 6th aspect of the present invention, preferably, the linear guide apparatus further comprises a rail cover mounted on the protrusion to cover the protrusion.

According to a 7th aspect of the present invention, there is provided a linear guide apparatus comprising:

a rail including:
rail track grooves formed respectively in two corner portions each defined by an upper surface of the rail and a respective one of opposite side surfaces of the rail; and
a positioning convex portion which is formed on the upper surface of the rail, and is disposed between the two rail track grooves;

a slider for linearly moving on the rail; and

a rail upper surface cover whose position in a widthwise direction is determined by the positioning convex portion of the rail, the rail upper surface cover having a concave portion corresponding to the positioning convex portion of the rail.

According to an 8th aspect of the present invention depending from the 7th aspect, preferably, the rail upper surface cover includes:

bent portions formed respectively by bending widthwise-opposite side portions at an arbitrary angle; and a flat surface portion provided between the two bent portions.

According to a 9th aspect of the present invention depending from the 8th aspect, preferably, the linear guide apparatus further comprises:

an adhesive layer which is provided between an inner surface of the flat surface portion of the rail upper surface cover and the upper surface of the rail to fix the inner surface of the flat surface portion of the rail upper surface cover and the upper surface of the rail to each other.

According to a 10th aspect of the present invention depending from the 9th aspect, preferably, a thickness of the adhesive layer is smaller than an inner depth of the bent portion.

According to an 11th aspect of the present invention depending from the 7th aspect, preferably, an axial length of the rail upper surface cover is generally equal to an axial length of the rail.

According to a 12th aspect of the present invention depending from the 7th aspect, preferably, the rail upper surface cover has end bent portions formed respectively at axially-opposite ends thereof, the end bent portions being bent to extend respectively along axially-opposite end surfaces of the rail.

According to a 13th aspect of the present invention depending from the 12th aspect, preferably, the linear guide apparatus further comprises axially-opposite end adhesive layers provided respectively on the axially-opposite ends of the rail, the end bent portions of the rail upper surface cover being fixed respectively to the axially-opposite ends of the rail through the respective axially-opposite end adhesive layers.

According to a 14th aspect of the present invention depending from the 7th aspect, preferably, the rail upper surface cover is formed of a resilient material.

According to a 15th aspect of the present invention, preferably, the bent portions of the rail upper surface cover are fitted to the positioning convex portion of the rail to be fixed to the rail.

According to a 16th aspect of the present invention depending from the 8th aspect, preferably, a slanting surface is formed on that portion of the rail lying between the rail rolling groove and the positioning convex portion with which the bent portion of the rail upper surface cover is contacted.

In the present invention, there is achieved an advantage that the rail cover, covering the mounting bolt holes, can be easily mounted on the rail by the use of the protrusion without preventing the rolling movements of balls in the rail track grooves even when the rail has the rail track grooves formed respectively in the corner portions each formed by the upper surface of the rail and the corresponding rail side surface.

And besides, the rail cover is mounted on the protrusion, and therefore there is achieved an advantage that the rail cover is prevented from being deformed, and a sealing performance of seal members can be sufficiently secured, thereby preventing the intrusion of foreign matters from the outside of the slider.

Furthermore, in the present invention, there is achieved an advantage that the rail cover, covering the rail mounting holes open to the rail upper surface, can be mounted on the rail without forming any groove portion and screw hole in the rail, and the time, required for producing the rail having the rail cover mounted thereon, can be reduced, thereby enhancing the efficiency of the production thereof. And besides, the adhesive material is covered with the bent portions, and therefore there is achieved an advantage that even when the linear guide apparatus is used in an environment in which a water soluble material such as a coolant is splashed on the apparatus, the deterioration of the adhesive due to the intrusion of the water soluble material or other factors can be prevented, and the lift-up and disengagement of the rail cover can be prevented for a long period of time.

### BRIEF DESCRIPTION OF THE DRAWINGS

FIG. 1 is a front-elevational view showing a linear guide apparatus of Embodiment 1;

FIG. 2 is a perspective view showing the linear guide apparatus of Embodiment 1;

FIG. 3 is an enlarged fragmentary view showing a rail and a rail cover of Embodiment 1;

FIG. 4 is an enlarged fragmentary view showing a rail and a rail cover of Embodiment 2;

FIG. 5 is an enlarged fragmentary view showing another form of rail and rail cover of Embodiment 2;

FIG. 6 is an enlarged fragmentary view showing a rail and a rail cover of Embodiment 3;

FIG. 7 is an enlarged fragmentary view showing a rail and a rail cover of Embodiment 4;

FIG. 8 is a front-elevational view showing a linear guide apparatus of Embodiment 5;

FIG. 9 is a perspective view showing the linear guide apparatus of Embodiment 5;

FIG. 10 is an enlarged fragmentary view showing a rail and a rail cover of Embodiment 5;

FIG. 11 is a perspective view showing a mounted condition of a rail cover of Embodiment 6;

FIG. 12 is an enlarged fragmentary view showing a rail and the rail cover of Embodiment 6;

FIG. 13 is an enlarged fragmentary view showing a rail and a rail cover of Embodiment 6;

FIG. 14 is a perspective view showing a mounted condition of a rail cover of Embodiment 7; and

FIG. 15 is a perspective view showing a mounted condition of another form of rail cover of Embodiment 7.

### DETAILED DESCRIPTION OF THE PREFERRED EMBODIMENTS

Embodiments of linear guide apparatuses of the present invention will now be described with reference to the drawings.

### Embodiment 1

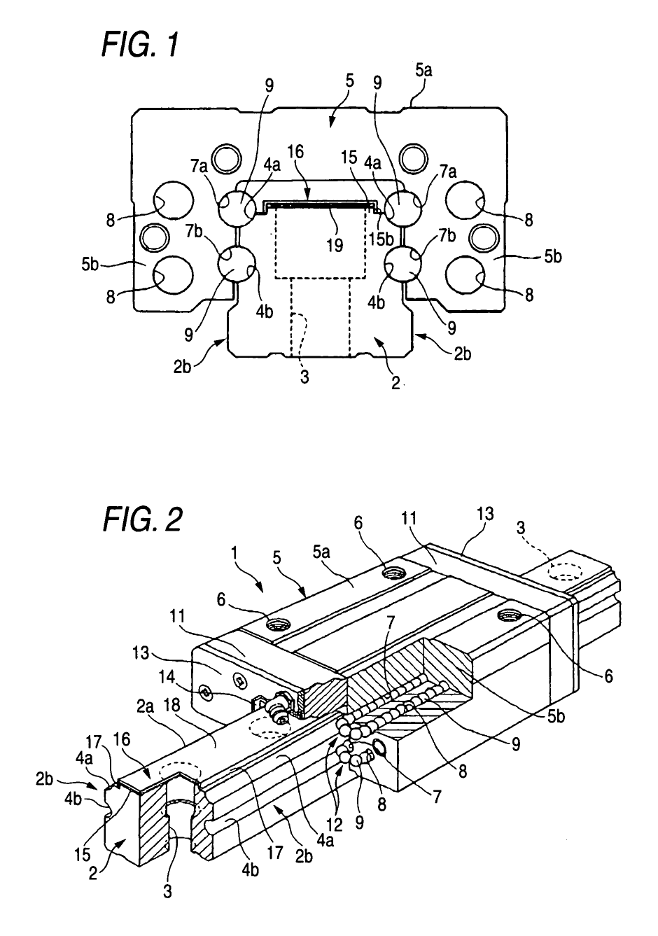

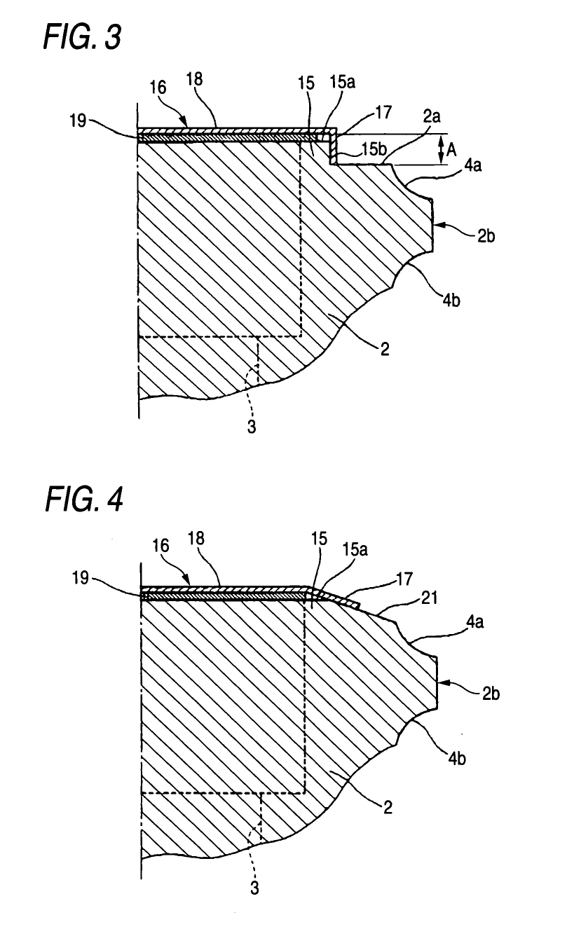

FIG. 1 is a front-elevational view showing a linear guide apparatus of Embodiment 1, FIG. 2 is a perspective view showing the linear guide apparatus of Embodiment 1, and FIG. 3 is an enlarged fragmentary view showing a rail and a rail cover of Embodiment 1.

FIG. 1 is the front-elevational view showing a condition in which end caps and side seals are removed.

In FIGS. 1 and 2, reference numeral 1 denotes the linear guide apparatus.

Reference numeral 2 denotes the rail of the linear guide apparatus 1, and the rail is a long bar-like member made of a steel material such as an alloy steel, and a plurality of rail mounting holes 3 (which are stepped bolt holes) are formed through the rail 2 in a direction of a height thereof, and are arranged at a predetermined pitch in a longitudinal direction thereof. The rail 2 is fastened to a base bed or the like of a machinery by bolts or the like, using these rail mounting holes 3, and is mounted thereon.

Rail track grooves 4a, 4b, serving as rail rolling member guide surfaces, are formed in each of opposite side surfaces (rail side surfaces 2b) of the rail 2, and extend in the longitudinal direction of the rail. The rail track grooves 4a each in the form of a groove of a generally quarter-circle arc-shape are formed respectively in corner portions each formed by an upper surface (rail upper surface 2a) of the rail 2 and a respective one of the rail side surfaces 2b, and the rail track grooves 4b each in the form of a groove of a generally half-circle arc-shape are formed respectively in the rail side surfaces 2b.

Reference numeral 5 denotes a slider which is a saddle-like member made of a steel material such as alloy steel and having a generally channel-shaped cross-section, and mounting screw holes 6 are formed in an upper surface thereof (slider upper surface 5a). A carriage or the like of the machinery is fastened to the slider by bolts or the like, using these mounting screw holes 6.

Slider track grooves 7a, 7b, serving as slider rolling member guide surfaces, are formed in an inner surface of each of opposite side walls 5b of the slider 5 in opposed relation to the rail track grooves 4a, 4b (the rail track grooves 4 unless necessary to distinguish them from each other). Return passageways 8 (which are through holes larger in diameter than balls 9 serving as rolling members) are formed in thickened portions of the slider side walls, and extend through the slider 5 in a direction of movement of the slider (in a slider moving direction) in corresponding relation to the slider track grooves 7a, 7b (the slider track grooves 7 unless necessary to distinguish them from each other).

The ball 9 is a spherical member made of a steel material such as alloy steel.

Reference numeral 11 denotes the end cap, and these end caps are made of a metal material or a resin material, and are provided respectively at front and rear (in the slider moving direction) ends of the slider 5, and direction-changing passageways 12 (which are curved passageways), connecting load passageways (described later) to the respective return passageways 8 of the slider 5, are formed in that portion of each end cap disposed close to the slider 5.

Reference numeral 13 denotes the side seal, and this side seal comprises a metal base formed by a sheet member made of alloy steel or the like, and a seal portion 14 which is provided at that portion of the metal base disposed close to the rail 2, and is made of natural rubber, synthetic rubber or the like. These side seals are provided respectively at outer end surfaces of the end caps 11, and are mounted, together with the end caps 11, on the slider 5 by fastening means such as bolts.

The load passageways are formed by the slider track grooves 7 and the rail track grooves 4 opposed respectively to these slider track grooves 7, and the balls 9 roll in these load passageways to support the load of the slider 5 moving on the rail 2. Opposite ends of each load passageway are interconnected by the direction-changing passageways 12 of the end caps 11 and the return passageway 8 of the slider 5, thereby forming a circulating passageway in which the balls 9 are circulated in accordance with the movement of the slider 5. In this embodiment, two circulating passageways are provided at each side of the rail 2, and therefore with respect to the opposite sides of the rail, there are provided four circulating passageways.

The plurality of balls 9 are, together with a predetermined amount of a lubricant (for example, grease), are sealed in each circulating passageway, and the balls 9, rolling in the load passageways, support the load, applied to the slider 5, so as to enable the reciprocal movement of the slider, and the slider 5 is supported so as to reciprocally move in the longitudinal direction of the rail 2.

Reference numeral 15 denotes a protrusion, and this protrusion is a projecting portion of a rectangular cross-section which is formed on and projects from the rail upper surface 2a, and extends in the longitudinal direction of the rail 2 over an entire length thereof. A length (width) of the protrusion in its transverse direction is larger than a diameter (bore) of a larger-diameter portion of the rail mounting hole 3, and is smaller than the distance between the portions of the rail upper surface 2a connected respectively to the rail track grooves 4a formed respectively in the upper portions of the opposite sides of the rail 2 (that is, the distance between the edges of the rail track grooves 4a).

Therefore, each rail mounting hole 3 is formed as the stepped bolt hole extending from an upper surface (protrusion upper surface 15a) of the protrusion 15 to a lower surface of the rail 2.

Reference numeral 16 denotes the rail cover, and using a resilient material having resiliency such as a thin sheet of stainless steel or a resin material such as polyprene, polyacetal, polyethylene and nylon, this rail cover is formed into a length generally equal to the longitudinal length of the rail 2. As shown in FIG. 3, the rail cover includes bent portions 17 formed respectively by bending longitudinal-extending opposite side edge portions thereof at right angles, and a flat surface portion 18 which lies between the two bent portions 17, and has a width equal to the width of the protrusion upper surface 15a, and has a flat surface parallel to the protrusion upper surface 15a. Surfaces (inner surfaces) of the bent portions 17, facing the protrusion 15, are fitted respectively to side surfaces (fitting surfaces 15b) of the protrusion 15 formed parallel to the direction of the height of the rail 2.

Reference numeral 19 denotes an adhesive tape serving as an adhesive layer, and this is an adhesive tape having a water-resistant adhesive coated on both sides thereof. A thickness of this adhesive tape is slightly smaller than a length obtained by subtracting a height of the fitting surface 15b of the protrusion 15 from a depth (inner depth A as shown in FIG. 3) between a surface (inner surface) of the flat surface portion 18 of the rail cover 16 (facing the rail upper surface 2a) and a distal end of the bent portion 17, that is to say, slightly smaller than a gap formed between the inner surface of the flat surface portion 18 and the protrusion upper surface 15a when the distal end of each bent portion 17 abuts against the rail upper surface 2a. The adhesive tape adhesively bonds the inner surface of the flat surface portion 18 of the rail cover 16 to the protrusion upper surface 15a.

The adhesive tape 19 of this embodiment is obtained by cutting a VHB acrylic foam structural bonding tape (manufactured by SUMITOMO 3M Kabushiki Kaisha) into a size conforming to the width and entire length of the flat surface portion 18 of the rail cover 16.

For mounting the rail cover 16 on the rail 2, one side of the adhesive tape 19 is bonded to the inner surface of the flat surface portion 18 of the rail cover 16, and the inner surfaces of the two bent portions 17 are forced along the respective fitting surfaces 15b of the protrusion 15, and by pressing the flat surface portion 18, using the resiliency of the rail cover 16, the other side of the adhesive tape 19 is adhesively bonded to the protrusion upper surface 15a, and the rail cover 16 is mounted on the rail 2 in such a manner that the inner surfaces of the bent portions 17 of the rail cover 16 are fitted respectively to the fitting surfaces 15b.

As a result, the rail cover 16 covers the rail mounting holes 3, open to the protrusion upper surface 15a of the rail 2, over the entire length of the rail 2, so that the intrusion of foreign matters into the rail mounting holes 3, as well as the deposition of foreign matters in these holes, can be prevented.

And besides, the protrusion 15 is formed on the rail upper surface 2a, and the rail cover 16 is fitted on this protrusion, and is adhesively bonded thereto by the adhesive tape 19, thereby mounting the rail cover on the rail. Therefore, when the width of the protrusion 15, formed on the rail upper surface 2a, is set to a value equal to a lower limit of the width between the inner side surfaces of the bent portions 17 of the rail cover 16, the rail 2 can be easily produced without deforming the flat surface portion 18 of the rail cover 16, using ordinary dimensional accuracy. And besides, when the slider 5 moves on the rail 2, a lip portion of the seal portion 14 of each side seal 13 slides over the cover upper surface of the rail cover 16 which is not deformed, the rail upper surface 2a, etc., and therefore a sufficient sealing performance can be secured, and the intrusion of foreign matters from the outside of the slider 5, as well as the leakage of the lubricant from the inside, can be prevented. Furthermore, the rail cover 16, covering the mounting bolt holes 3, can be easily mounted on the rail without preventing the rolling movements of the balls in the rail track grooves 4a even when the rail 2 has the rail track grooves 4a formed respectively in the corner portions each formed by the rail upper surface 2a and the corresponding rail side surface 2b.

Furthermore, the protrusion 15 has the rectangular cross-sectional shape, and the fitting surfaces 15b are formed as the vertical surfaces, respectively, and therefore the positioning of the rail cover 16 in the direction of the width of the rail 2 can be easily effected.

Furthermore, the adhesive tape 19 is covered with the bent portions 17, and therefore even when the linear guide apparatus 1 is used in an environment in which a water soluble material such as a coolant is splashed on the apparatus, the deterioration of the adhesive due to the intrusion of the water soluble material or other factors can be prevented, and the lift-up and disengagement of the rail cover 16 can be prevented for a long period of time.

As described above, in this embodiment, the rail cover includes the bent portions formed respectively by bending the opposite side edge portions thereof at right angles, and the flat surface portion lying between the bent portions, and this rail cover is fitted on the protrusion of the rectangular cross-sectional shape formed on the rail upper surface, and is mounted on this protrusion, and with this construction the rail cover, covering the mounting bolt holes, can be easily mounted on the rail by the use of the protrusion without preventing the rolling movements of the balls in the rail track grooves even when the rail has the rail track grooves formed respectively in the corner portions each formed by the rail upper surface and the corresponding rail side surface. And besides, since the rail cover will not be deformed, the sufficient sealing performance can be secured, so that foreign matters can be prevented from intruding from the exterior of the slider.

Furthermore, the protrusion of the rectangular cross-sectional shape is formed on the rail upper surface, and the rail cover, having the bent portions formed respectively by bending the opposite side edge portions thereof at right angles, is fitted on the protrusion, and by doing so, the positioning of the rail cover in the direction of the width of the rail can be easily effected.

### Embodiment 2

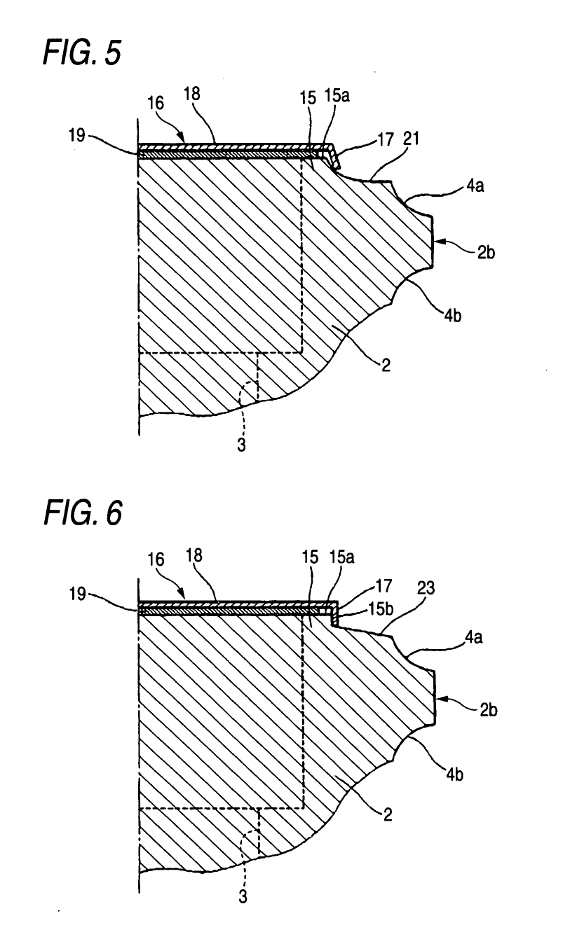

FIG. 4 is an enlarged fragmentary view showing a rail and a rail cover of Embodiment 2.

Those portions similar to those of the above Embodiment 1 will be designated by identical reference numerals, respectively, and explanation thereof will be omitted.

In FIG. 4, reference numeral 21 denotes an inclination surface serving as a slanting surface, and a protrusion 15 is formed on a rail upper surface 2a, and has a width larger than a bore of each rail mounting hole 3, and the inclination surfaces are defined respectively by flat surfaces which are formed respectively at opposite side corner portions of the protrusion 15 extending in a longitudinal direction of a protrusion upper surface 15a, and are slanting from the protrusion upper surface 15 toward a lower surface of the rail 2 in such a manner that the distance between the two flat surfaces in the widthwise direction is increasing. Therefore, the protrusion 15 of this embodiment has a trapezoidal cross-sectional shape.

In this case, preferably, the angle of inclination of each inclination surface 21 relative to a horizontal plane is not smaller than 10 degrees. By setting the inclination to this angle, the working for forming the inclination surface 21 can be easily effected from the rail side surface (2b) side as described later.

As shown in FIG. 4, the rail cover 16 of this embodiment includes bent portions 17 formed respectively by bending longitudinally-extending opposite side edge portions thereof at an angle (obtuse angle) larger than 90 degrees so that these opposite side edge portions can extend respectively along the inclination surfaces 21, and a flat surface portion 18 which lies between the two bent portions 17, and has a flat surface parallel to the protrusion upper surface 15a. A width between distal ends of the bent portions 17 is smaller than the distance between edges of rail track grooves 4a, formed respectively at the opposite sides, so that these bent portions will not interfere with balls 9 rolling in the upper rail track grooves 4a.

Since no horizontal surface exists, the working for forming the inclination surface 21 can be effected from the rail side surface (2b) side simultaneously with the working for forming the rail side surface 2b and rail track grooves 4a, 4b, and an error in parallelism of the protrusion 15 relative to the rail side surface 2b can be kept to a low level, and besides time and labor, required for the working, will not increase, and therefore the production cost will not increase.

Such simultaneous working can be effected by a grinding operation using a form grinding stone. When the slanting surface 21, that is, the surface lying between the edge of the upper rail track groove 4a and the protrusion upper surface 15a, is the ground surface, the sealing performance, achieved by the seal members 14, will not be adversely affected even if the shape is somewhat complicated.

A thickness of an adhesive tape 19 of this embodiment is smaller than an inner depth A of the rail cover 16, and is so determined that when the rail cover 16 is adhesively bonded to the protrusion upper surface 15a, the inner surface of each bent portion 17 is slightly pressed against the slanting surface 21 by its own resiliency.

For mounting the rail cover 16 on the rail 2, one side of the adhesive tape 19 is bonded to the inner surface of the flat surface portion 18 of the rail cover 16, and the rail cover is located in such a manner that the inner surfaces of the bent portions 17 abut respectively against the inclination surfaces 21, and the upper surface of the rail cover 16 is pressed, using the resiliency of this cover, thereby adhesively bonding the other side of the adhesive tape 19 to the protrusion upper surface 15a, thus mounting the rail cover 16 on the rail 12 in such a manner that the inner surfaces of the bent portions 17 are slightly pressed respectively against the inclination surfaces 21.

As described above, in this embodiment, in addition to advantages similar to those of the above Embodiment 1, the inner surfaces of the bent portions of the rail cover abut respectively against the inclination surfaces formed respectively at the corner portions of the protrusion formed on the rail upper surface, and by doing so, the mountability of the rail cover relative to the rail can be enhanced. And besides, in the production of the rail, the working for forming the rail track grooves, etc., at each rail side surface can be effected simultaneously with the working for forming the inclination surface, and the protrusion can be formed without increasing the steps of the working process.

In this embodiment, although description has been made of the case where each slanting surface, formed on the protrusion, is defined by one inclination surface formed on each of the opposite side portions of the protrusion, the slanting surface may be formed by a combination of a plurality of inclination surfaces, or the slanting surface may be formed by an inwardly-convex arc-shaped surface as shown in FIG. 5.

Even with such a construction, similar advantages as described above can be obtained with respect to the mountability and workability, and besides the surface between each upper rail track groove and the protrusion upper surface can be formed as a ground surface, so that the sealing performance, achieved by the seal members, can be enhanced.

### Embodiment 3

FIG. 6 is an enlarged fragmentary view showing a rail and a rail cover of Embodiment 3.

Those portions similar to those of the above Embodiment 1 will be designated by identical reference numerals, respectively, and explanation thereof will be omitted.

In FIG. 6, reference numeral 23 denotes a slanting upper surface which is a slanting rail upper surface formed between a lower edge of a fitting surface 15b of a protrusion 15 (formed in the same manner as described above for Embodiment 1) and an edge of a rail track groove 4a while the fitting surface 15b remains adjacent to a protrusion upper surface 15a of the protrusion 15.

Therefore, a rail cover 16 of this embodiment is similar to the rail cover 16 of Embodiment 1, but a length of each bent portion 17 thereof is made smaller by an amount equal to a height (height of a mountain) of a connected portion (of the slanting upper surface 23 and the fitting surface 15b) from a position corresponding to the rail upper surface 2a of Embodiment 1.

For mounting the rail cover 16 on the rail 2, the rail cover 16 is adhesively bonded to the ride upper surface 15a by an adhesive tape 19 as in the above Embodiment 1, and is mounted on the rail.

In this construction, each fitting surface 15b, disposed adjacent to the protrusion upper surface 15a of the protrusion 15, is formed as a vertical surface, and therefore the positioning of the rail cover 16 in the direction of the width of the rail 2 can be easily effected as in Embodiment 1.

And besides, no horizontal surface exists, and therefore the working for forming the fitting surface 15b and the slanting upper surface 23 can be effected from the rail side surface (2b) side simultaneously with the working for forming a rail side surface 2b and rail track grooves 4a, 4b as in Embodiment 2, and an error in parallelism of the protrusion 15 relative to the rail side surface 2b can be kept to a low level, and besides time and labor, required for the working, will not increase, and therefore the production cost will not increase.

As described above, in this embodiment, in addition to advantages similar to those of the above Embodiment 1, similar advantages to those of the above Embodiment 2 can be obtained.

### Embodiment 4

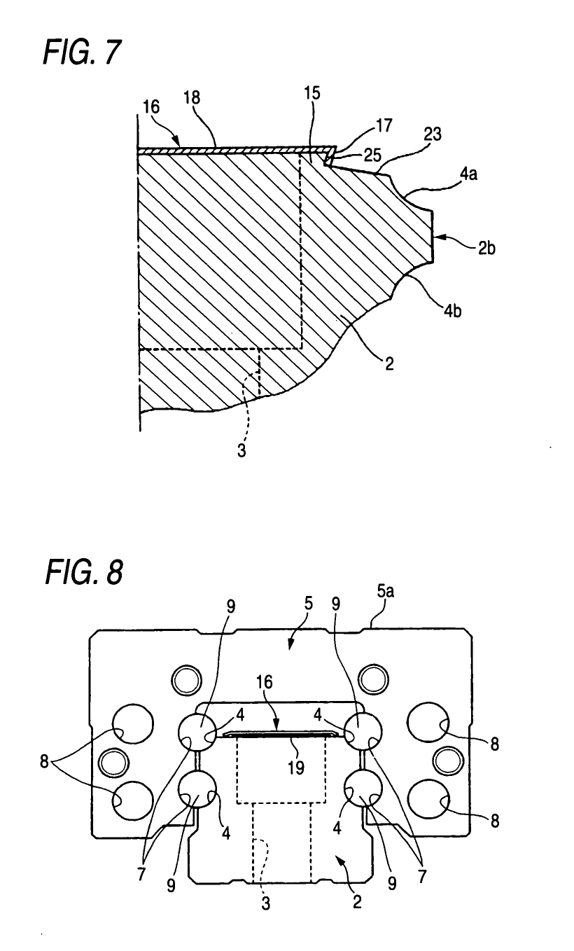

FIG. 7 is an enlarged fragmentary view showing a rail and a rail cover of Embodiment 4.

Those portions similar to those of the above Embodiment 1 and Embodiment 3 will be designated by identical reference numerals, respectively, and explanation thereof will be omitted.

In FIG. 7, reference numeral 25 denotes an engagement surface which is a flat surface, and these flat surfaces are defined respectively by side surfaces (remaining as the respective fitting surfaces 15b in the above Embodiment 3) which are disposed adjacent to a protrusion upper surface 15a of a protrusion 15, and are slanting toward a lower surface of the rail 2 in such a manner that the distance between the two flat surfaces in the widthwise direction is decreasing.

As shown in FIG. 7, the rail cover 16 of this embodiment includes bent portions 17 formed respectively by bending longitudinally-extending opposite side edge portions thereof at an angle (acute angle) smaller than 90 degrees so that these opposite side edge portions can extend respectively along the engagement surfaces 25, and a flat surface portion 18 which lies between the two bent portions 17, and has a flat surface parallel to the protrusion upper surface 15a. A width between distal ends of the bent portions 17 is smaller than a width of the protrusion upper surface 15a so that these distal ends can extend along the respective engagement surfaces 25 of the protrusion 15.

In this embodiment, the use of an adhesive layer 19 is omitted.

An inner depth A of the rail cover 16 is slightly larger than the height of the engagement surface 25.

When the rail cover 16, having such bent portions 17, is to be mounted on the rail 2 having the engagement surfaces 25, the rail cover 16 is inclined, and the bent portion 17 is engaged with one engagement surface 25, and in this condition the other bent portion 17 is expanded by its resiliency, and is engaged with the other engagement surface 25, thereby mounting the rail cover 16 on the rail 2.

In this construction, the engagement surfaces 25, slanting toward the lower surface of the rail 2 in such a manner that the distance therebetween in the widthwise direction is decreasing, are formed on the protrusion 15, and therefore the positioning of the rail cover 16 in the direction of the width of the rail 2 can be easily effected as in Embodiment 1.

And besides, no horizontal surface exists, and therefore the working for forming the engagement surface 25 and a slanting upper surface 23 can be effected from the rail side surface (2b) side simultaneously with the working for forming a rail side surface 2b and rail track grooves 4a, 4b as in Embodiment 2, and an error in parallelism of the protrusion 15 relative to the rail side surface 2b can be kept to a low level, and besides time and labor, required for the working, will not increase, and therefore the production cost will not increase.

Furthermore, the engagement surfaces 25 of the protrusion 15 are defined respectively by the flat surfaces which are slanting toward the lower surface of the rail 2 in such a manner that the distance therebetween in the widthwise direction is decreasing, and therefore by engaging the bent portions 17 (bent at the acute angle) with the respective engagement surfaces, the rail cover 16 can be easily mounted on the protrusion 15 of the rail 2 without using an adhesive layer such as an adhesive tape 19, and the production cost of a linear guide apparatus can be reduced.

As described above, in this embodiment, in addition to advantages similar to those of the above Embodiment 1 and Embodiment 2, the engagement surfaces, slanting toward the lower surface of the rail in such a manner that the distance therebetween in the widthwise direction is decreasing, are formed respectively on the side surfaces of the protrusion, and by doing so, the rail cover can be mounted on the protrusion of the rail without using an adhesive material such as an adhesive tape, and the production cost of the linear guide apparatus can be reduced.

### Embodiment 5

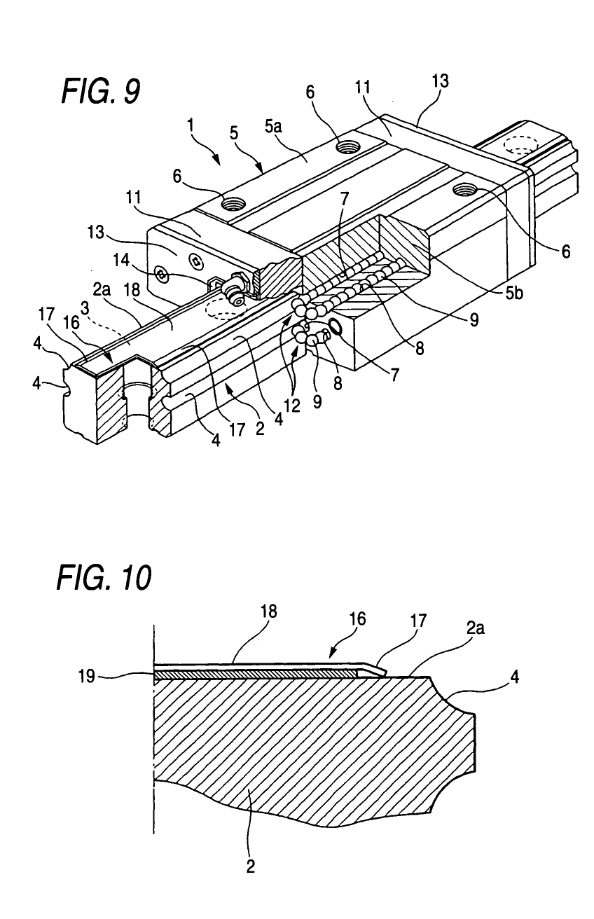

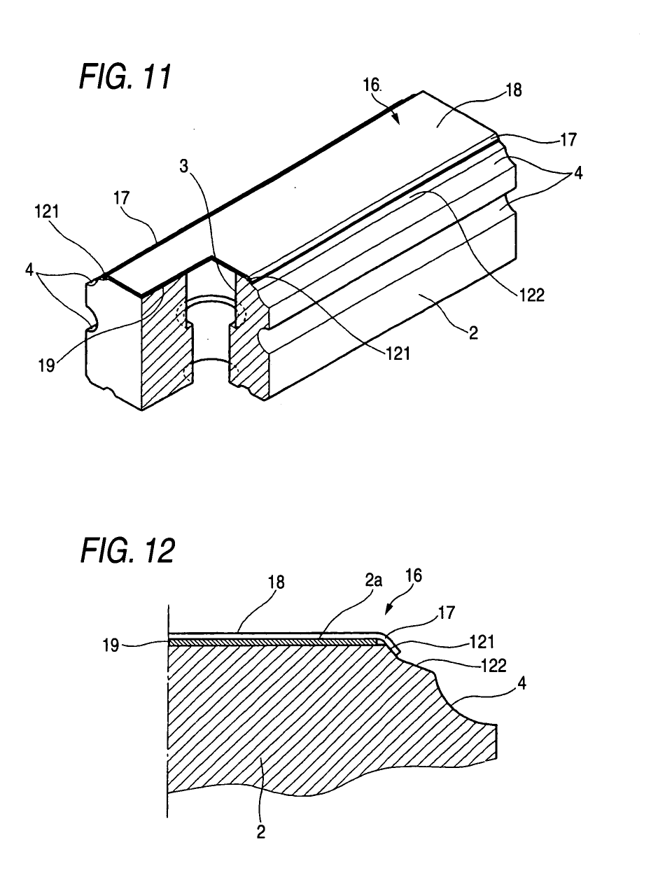

FIG. 8 is a front-elevational view showing a linear guide apparatus of Embodiment 5, FIG. 9 is a perspective view showing the linear guide apparatus of Embodiment 5, and FIG. 10 is an enlarged fragmentary view showing a rail and a rail cover of Embodiment 5.

FIG. 8 is the front-elevational view showing a condition in which end caps and side seals are removed.

Those portions similar to those of the above Embodiment 1 will be designated by identical reference numerals, respectively, and explanation thereof will be omitted.

Reference numeral 16 denotes the rail cover, and using a resilient material having resiliency such as a thin sheet of stainless steel or the like or a resin material such as polyprene, polyacetal, polyethylene and nylon, this rail cover is formed into a length generally equal to a longitudinal length of the rail 2. As shown in FIG. 10, the rail cover includes bent portions 17 formed respectively by bending longitudinally-extending opposite side edge portions thereof at an angle (obtuse angle) larger than 90 degrees, and a flat surface portion 18 which lies between the two bent portions 17, and has a width larger than a diameter of a larger-diameter portion of each rail mounting hole 3, and has a flat surface extending along a rail upper surface 2a.

Reference numeral 19 denotes an adhesive tape serving as an adhesive layer, and this is an adhesive tape having a water-resistant adhesive coated on both sides thereof. A thickness of this adhesive tape is smaller than a depth (inner depth A) between a surface (inner surface) of the rail cover, facing the rail upper surface 2a, and a distal end of the bent portion 17 (which has been bent), and this adhesive tape adhesively bonds the inner surface of the flat surface portion 18 of the rail cover 16 to the rail upper surface 2a. The adhesive tape 19 of this embodiment is obtained by cutting a VHB acrylic foam structural bonding tape (manufactured by SUMITOMO 3M Kabushiki Kaisha) into a size conforming to the width and entire length of the flat surface portion 18 of the rail cover 16.

For mounting the rail cover 16 on the rail upper surface 2a, one side of the adhesive tape 19 is bonded to the inner surface of the flat surface portion 18 of the rail cover 16, and the rail cover is located at a generally central portion of the rail upper surface 2a along the longitudinal direction to cover the rail mounting holes 3 open to the rail upper surface 2a, with the distal ends of the bent portions 17 abutting against the rail upper surface 2a, and by pressing the cover upper surface, using the resiliency of the rail cover 16, the other surface of the adhesive tape 19 is adhesively bonded to the rail upper surface 2a, thereby mounting the rail cover 16 on the rail upper surface 2a.

As a result, the rail cover 16 covers the rail mounting holes 3, open to the rail upper surface 2a of the rail 2, over the entire length of the rail 2, so that the intrusion of foreign matters into the rail mounting holes 3, as well as the deposition of production chips or the like in these holes, can be prevented.

And besides, when a slider 5 of the linear guide apparatus 1 moves on the rail 2, a lip portion of a seal portion 14 of each side seal 13 slides over the rail upper surface 2a of the rail 2, the cover upper surface of the rail cover 16 and so on, and therefore the intrusion of foreign matters from the outside of the slider 5, as well as the leakage of a lubricant from the inside, can be prevented.

As described above, in this embodiment, the rail cover includes the bent portions formed respectively by bending the opposite side edge portions thereof at right angles, and the flat surface portion lying between the bent portions, and the rail upper surface is adhesively bonded to the inner surface of the flat surface portion by the adhesive tape. With this construction, the rail cover, covering the rail mounting holes open to the rail upper surface, can be mounted on the rail without forming any groove portion and screw hole in the rail, and the time, required for producing the rail having the rail cover mounted thereon, can be reduced, thereby enhancing the efficiency of the production thereof, and besides the production cost of the rail can be reduced. Furthermore, the adhesive tape is covered with the bent portions, and therefore even when the linear guide apparatus is used in an environment in which a water soluble material such as a coolant is splashed on the apparatus, the deterioration of the adhesive due to the intrusion of the water soluble material or other factors can be prevented, and the lift-up and disengagement of the rail cover can be prevented for a long period of time.

### Embodiment 6

FIG. 11 is a perspective view showing a mounted condition of a rail cover of Embodiment 6, and FIG. 12 is an enlarged fragmentary view showing a rail and the rail cover of Embodiment 6.

Those portions similar to those of the above Embodiment 5 will be designated by identical reference numerals, respectively, and explanation thereof will be omitted.

Reference numeral 121 denotes an abutment surface, and the abutment surfaces are defined respectively by inclination surfaces which are formed respectively at longitudinally-extending opposite side edges of a rail upper surface 2a, and are slanting downwardly from the rail upper surface 2a so as to extend respectively along inner surfaces of bent portions 17 of the rail cover 16 in such a manner that the distance between the two inclination surfaces in the widthwise direction is increasing. The inner surfaces of the bent portions 17 of the rail cover 16 abut against the abutment surfaces, respectively.

A slanting surface 122, having a spreading angle larger than the spreading angle of the abutment surface 121, is formed between the abutment surface 121 and an upper rail track groove 4 in order to avoid the interference of this portion with balls 9 rolling in the upper rail track groove 4.

The working for forming the abutment surface 121 and the slanting surface 122 can be effected simultaneously with the working for forming the rail track grooves 4 by grinding, and therefore time and labor, required for the working, will not increase. And besides, the working can be easily effected, and therefore the production cost will not increase.

A thickness of an adhesive tape 19 of this embodiment is smaller than an inner depth A of the rail cover 16, and is so determined that when the rail cover 16 is adhesively bonded to the rail upper surface 2a, the inner surfaces of the bent portions 17 are slightly pressed against the respective abutment surfaces 121 by their own resiliency.

For mounting the rail cover 16 on the rail upper surface 2a, one side of the adhesive tape 19 is bonded to an inner surface of a flat surface portion 18 of the rail cover 16, and the rail cover is located in such a manner that the inner surfaces of the bent portions 17 abut respectively against the abutment surfaces 121, and by pressing the cover upper surface, using the resiliency of the rail cover 16, the other surface of the adhesive tape 19 is adhesively bonded to the rail upper surface 2a, thereby mounting the rail cover 16 on the rail upper surface 2a in such a manner that the inner surfaces of the bent portions 17 are slightly pressed against the respective abutment surfaces 121.

As described above, in this embodiment, in addition to advantages similar to those of the above Embodiment 5, the inner surfaces of the bent portions of the rail cover abut respectively against the abutment surfaces formed respectively at the opposite side edges of the rail upper surface. With this construction, the positioning of the rail cover on the rail upper surface can be easily effected, and the mountability of the rail cover relative to the rail can be enhanced.

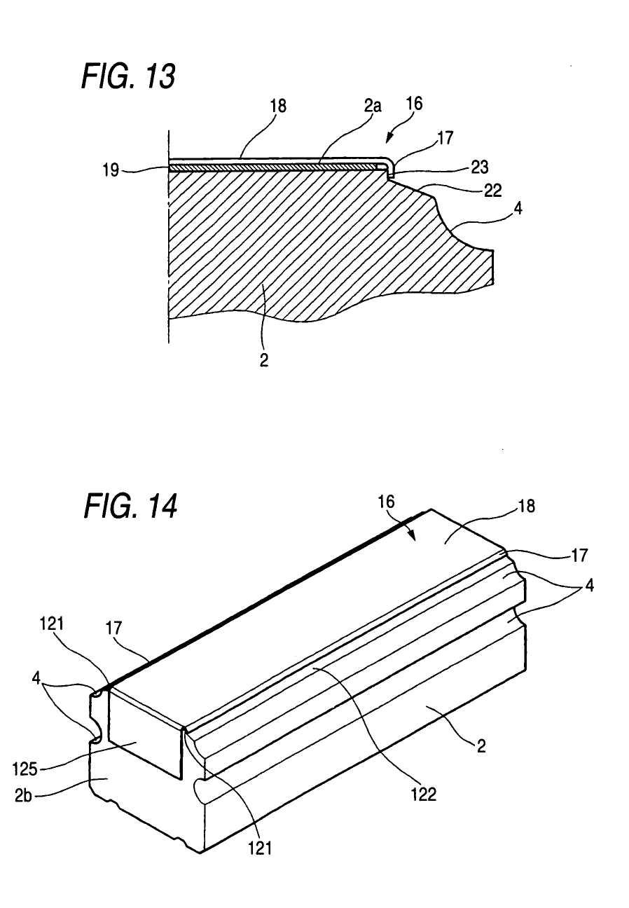

FIG. 13 is an enlarged fragmentary view showing another form of rail and rail cover of Embodiment 6.

In FIG. 13, reference numeral 123 denotes a fitting surface, and the fitting surfaces are formed respectively at longitudinally-extending opposite side edges of a rail upper surface 2a, and inner surfaces of bent portions 17, formed respectively by bending opposite side edge portions of a rail cover 16, are fitted to these fitting surfaces.

A slanting surface 122, having a spreading angle larger than the spreading angle of the fitting surface 123, is formed between the fitting surface 123 and an upper rail track groove 4 in order to avoid the interference of this portion with balls 9 rolling in the upper rail track groove 4, as described above.

A depth of the bent portion 17 of this embodiment, bent generally at right angles, is larger than a thickness of an adhesive tape 19, and is so determined that when the rail cover 16 is adhesively bonded at its flat surface portion 18 to the rail upper surface 2a, a distal end of the bent portion 17 will not abut against the slanting surface 122.

And besides, the distance between the inner surfaces of the bent portions 17 is slightly smaller than the distance between the two fitting surfaces 123 so that the inner surfaces of the bent portions 17 can be slightly pressed against the respective fitting surfaces 123 by the resiliency of the bent portions 17.

With this construction, also, similar advantages to those of the above-mentioned Embodiment 6 can be obtained.

### Embodiment 7

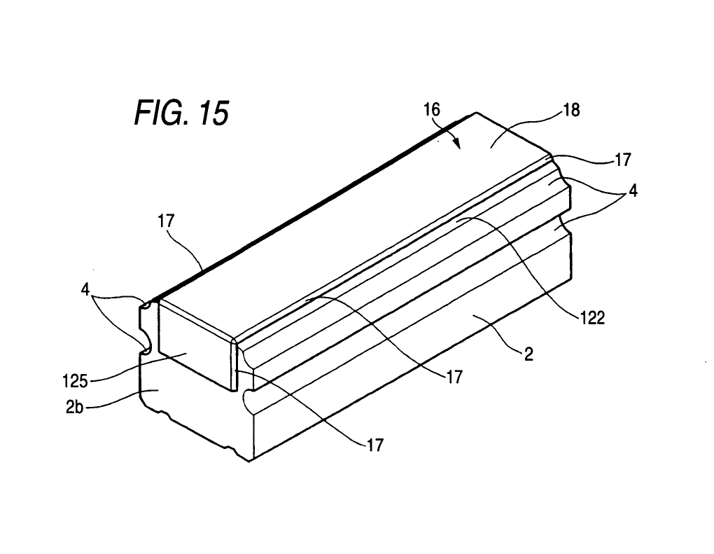

FIG. 14 is a perspective view showing a mounted condition of a rail cover of Embodiment 7.

Those portions similar to those of the above Embodiment 5 will be designated by identical reference numerals, respectively, and explanation thereof will be omitted.

In FIG. 14, reference numeral 25 denotes an end bent portion of the rail cover 16, and the rail cover 16 is formed into a length larger than a longitudinal length of a rail 2, and bent portions 17 are removed from extension portions of longitudinally-opposite end portions of the rail cover 16 extending respectively beyond rail end surfaces 2b of a rail 2, and these extension portions are bent to extend respectively along the rail end surfaces, thereby forming the end bent portions.

When the rail cover 16, having the end bent portions 125, is to be mounted on the rail upper surface 2a of Embodiment 6 having the abutment surfaces 121, the rail cover 16 is mounted on the rail upper surface 2a as described above for the above Embodiment 6, and thereafter surfaces of the end bent portions 125, opposed respectively to the rail end surfaces 2b, are adhesively bonded respectively to the rail end surfaces 2b by an adhesive tape 19, and are fixed thereto.

As described above, in this embodiment, in addition to advantages similar to those of the above Embodiment 6, the end bent portions, provided respectively at the longitudinally-opposite end portions of the rail cover, are adhesively bonded respectively to the rail end surfaces of the rail, and by doing so, the rail cover can be more firmly fixed to the rail upper surface.

In this embodiment, although description has been made of the case where the rail cover, having the end bent portions, is mounted on the rail of Embodiment 6, the rail cover can be mounted on the rail of Embodiment 5 in a similar manner.

The end bent portion 125 may have a shape shown in FIG. 15.

FIG. 15 is a perspective view showing a mounted condition of another form of rail cover of Embodiment 7.

End bent portions 125 of this embodiment are formed by merely bending extension portions of opposite end portions of the rail cover 16 without removing bent portions 17 from these extension portions. A portion of each end bent portion 125, corresponding to a flat surface portion 18, is adhesively bonded at one side thereof (facing a rail end surface 2b) to the rail end surface 2b by an adhesive tape 19, and is fixed thereto.

In the above Embodiments 1, 2, 3, 5, 6 and 7, explanation has been made of the case where the adhesive tape is bonded to the inner surface of the rail cover, and is pressed against the rail upper surface, thereby adhesively bonding the rail cover to the protrusion upper surface. However, the rail cover may be adhesively bonded to the protrusion upper surface by bonding the adhesive tape to the protrusion upper surface, then by putting the rail cover on the protrusion and then by pressing the upper surface of the cover.

Further, in the above Embodiments 1, 2, 3, 5, 6 and 7, although the adhesive layer has been described as being the adhesive tape having the adhesive coated on both sides thereof, the adhesive layer is not limited to it, and an adhesive of an acryl-type, a silicone-type or other type, having a water-resistance, can be coated on the protrusion upper surface or the inner surface of the rail cover so that it can be used as the adhesive.

Furthermore, in each of the above embodiments, although the linear guide apparatus, using the balls as the rolling members, has been described as the examples, the invention can be similarly applied to a linear guide apparatus using rollers as rolling members. In this case, rail rolling member guide surfaces and slider rolling member guide surfaces, forming load passageways, are formed by rail track surfaces and slider track surfaces on which rollers roll.

What is claimed is:

1. A linear guide apparatus comprising:
a rail comprising:
rail track grooves formed respectively in corner portions each formed by an upper surface of the rail and a respective one of widthwise-opposite side surfaces of the rail; and
a rail mounting hole extending through the rail in a direction of a height of the rail;
a slider for linearly moving on the rail; and
a protrusion which is formed on the upper surface of the rail, and has a width larger than a diameter of the rail mounting holes, and extends over an entire axial length of the rail.

2. The linear guide apparatus according to claim 1, wherein the protrusion has a rectangular cross-sectional shape.

3. The linear guide apparatus according to claim 1, wherein the protrusion has slanting surfaces formed respectively at two corner portions each defined by an upper surface of the protrusion and a respective one of widthwise-opposite side surfaces of the protrusion, the distance between the slanting surfaces in the widthwise direction being increasing toward a lower surface of the rail.

4. The linear guide apparatus according to claim 1, wherein each of the opposite side surfaces of the protrusion is formed by a plurality of inclination surfaces respectively having a plurality of angles relative to the upper surface of the rail.

5. The linear guide apparatus according to claim 1, wherein a surface, lying between the upper surface of the protrusion and the rail track groove, is a ground surface.

6. The linear guide apparatus according to claim 1, further comprising a rail cover mounted on the protrusion to cover the protrusion.

7. A linear guide apparatus comprising:
a rail including:
rail track grooves formed respectively in two corner portions each defined by an upper surface of the rail and a respective one of opposite side surfaces of the rail; and
a positioning convex portion which is formed on the upper surface of the rail, and is disposed between the two rail track grooves;
a slider for linearly moving on the rail; and
a rail upper surface cover whose position in a widthwise direction is determined by the positioning convex portion of the rail, the rail upper surface cover having a concave portion corresponding to the positioning convex portion of the rail.

8. The linear guide apparatus according to claim 7, wherein the rail upper surface cover includes:
bent portions formed respectively by bending widthwise-opposite side portions at an arbitrary angle; and
a flat surface portion provided between the two bent portions.

9. The linear guide apparatus according to claim 8, further comprising:
an adhesive layer which is provided between an inner surface of the flat surface portion of the rail upper surface cover and the upper surface of the rail to fix the inner surface of the flat surface portion of the rail upper surface cover and the upper surface of the rail to each other.

10. The linear guide apparatus according to claim 9, wherein a thickness of the adhesive layer is smaller than an inner depth of the bent portion.

11. The linear guide apparatus according to claim 7, wherein an axial length of the rail upper surface cover is generally equal to an axial length of the rail.

12. The linear guide apparatus according to claim 7, wherein the rail upper surface cover has end bent portions formed respectively at axially-opposite ends thereof, the end bent portions being bent to extend respectively along axially-opposite end surfaces of the rail.

13. The linear guide apparatus according to claim 12, further comprising axially-opposite end adhesive layers provided respectively on the axially-opposite ends of the rail, the end bent portions of the rail upper surface cover being fixed respectively to the axially-opposite ends of the rail through the respective axially-opposite end adhesive layers.

14. The linear guide apparatus according to claim 7, wherein the rail upper surface cover is formed of a resilient material.

15. The linear guide apparatus according to claim 8, wherein the bent portions of the rail upper surface cover are fitted to the positioning convex portion of the rail to be fixed to the rail.

16. The linear guide apparatus according to claim 8, wherein a slanting surface is formed on that portion of the rail lying between the rail rolling groove and the positioning convex portion with which the bent portion of the rail upper surface cover is contacted.
